(19) United States
(12) Patent Application Publication
(10) Pub. No.: US 2003/0141253 A1
(43) Pub. Date: Jul. 31, 2003

(54) Apparatus for efficient liquid chromatography/mass spectrometry processing

(76) Inventor: Thierry Le Bihan, Mississauga (CA)

Correspondence Address: ROPES & GRAY LLP, ONE INTERNATIONAL PLACE, BOSTON, MA, 02110-2624, US

(21) Appl. No.: 10/309,937

(22) Filed: Dec. 4, 2002

Related U.S. Application Data
(60) Provisional application No. 60/341,003, filed on Dec. 7, 2001.

(51) Int. Cl. B01D 15/08

(52) U.S. Cl. 210/656; 210/198.2

(57) ABSTRACT

A chromatographic apparatus includes at least one sample preparation stage with a plurality of individually mounted separation columns, that can have a common pressurizable header at the column input side for parallel sample preparation. The column output side can be releasably connected to a mass spectrometer input operating, for example, with ESI. The sample preparation stage is moveable in at least one direction for sequential processing of the columns by the mass spectrometer. Sample preparation and analysis can be automatically controlled.

### REFERENCE TO RELATED APPLICATION

This application claims priority to U.S. Provisional Application No. 60/341,003, filed on Dec. 7, 2001, the entire content of which is incorporated by reference herein.

### FIELD OF THE INVENTION

The invention is directed to a liquid chromatography/mass spectrometry (LC/MS) system, and more particularly to a system operating in a nanoflow regime and designed for a high sample throughput.

### BACKGROUND OF THE INVENTION

Liquid chromatography (LC), especially liquid chromatography usually referred to as high performance liquid chromatography (HPLC), has emerged as a technique of choice for the separation of highly complex biological mixtures. LC can be conducted with one or more columns, with column switching being used to separate a sample on a system of several columns, where the columns have a similar or different stationary phase. An example of column switching involves injection of the sample onto an column, elution of the peaks of interest, and back-flushing of the column. The back-flushing technique is commonly used to remove from the column material that is strongly retained on the column. Since the sample preparation with LC can take from several minutes to hours per sample, having only a single column or a small number of columns tends to make the analysis of complex samples a slow and tedious process. Moreover, the sample quantity available for analysis can be quite small, so that the columns need to have a small diameter so as to be able to separate the elution peaks without loss of separation. Modern mass spectrometers (MS) are capable of analyzing low femto-mole amounts of sample in a volume of 1 μL with sample flow rates of <5 nL/min. These low sample flow rates are sometimes also referred to a “nanoflow” range.

With MS analyses times in the order of a minute or at most several minutes, LC sample preparation tends to represent a bottleneck in LC/MS characterization. It would therefore be desirable to couple an efficient LC sample preparation technique with a MS analysis that can reliably separate and identify HPLC peaks even when using small sample quantities.

### SUMMARY OF THE INVENTION

According to one aspect of the invention, a liquid chromatography/mass spectrometry (LC/MS) system includes an arrayed arrangement of a plurality of micro-LC columns, for off-line sample preparation, high throughput mass spectrometry analysis, and an overall control system. In certain embodiments, the array of miniature LC columns is arranged in a single molded piece (e.g., similar in size/dimension to a 96 well-plate). The columns are specifically designed to operate under nanoflow conditions. Samples can be automatically and simultaneously spotted onto the columns and run through the column by pressurizing the entire headspace above the columns. Samples are then eluted directly into the mass spectrometer by placing the column plate in an X-Y positioner and sequentially injecting the contents of each column into the MS. High throughput is attained not only by the fast injection of the 96 samples, but also by the fact that other plates can be prepared off-line and quickly inserted into the injector apparatus.

For instance, the subject invention provides an arrayed chromatography device that includes a plurality of individually mounted chromatography columns. Each of the chromatography columns includes first and second connecting elements disposed at respective ends of the chromatography column. At the input end of the column, the connecting elements are able to form a fluid connection with a header adapted to drive a solution of sample and/or solute through the respective chromatography column. In preferred embodiments, the columns are dimensioned to operate under nanoflow conditions, an even more preferably, each of the chromatography columns has an inside diameter of between 5 and 200 μm.

Thus one aspect of the invention provides a mass-spectrometer-coupled chromatographic device/apparatus comprising: (a) at least one sample preparation stage having a plurality of individually mounted separation columns, with each of the separation columns having first and second connecting elements disposed at respective ends of the separation column, said first connecting elements of the separation columns connectable to a header adapted to drive a content representing a sample and/or a solute through the respective separation column, and (b) a mass spectrometer located in a sample analysis area and having an input coupling adapted to receive a column effluent for analysis, wherein the sample preparation stage is moveable in at least one direction for releasably connecting the second connecting elements of the separation columns sequentially to the input coupling of the mass spectrometer.

In certain preferred embodiments, the input coupling of the mass spectrometer includes an electro-spray ionization (ESI) device.

In certain preferred embodiments, each of the separation columns of the plurality of columns (of either the arrayed columns or those columns used in the MS-coupled chromatographic device) has an inside diameter of between 5 and 200 μm.

In certain preferred embodiments, separation columns operate efficiently at a flow rate of the sample and/or solute through the respective separation column of liquid flow rates of less than 1 μl/min.

In certain preferred embodiments, said header includes a common header space for at least a subset of the separation columns with a predetermined pressure. Said pressure can be uniform over the separation columns; alternatively, said pressure has a predetermined gradient over the separation columns.

In certain preferred embodiments, the apparatus further comprises a plurality of sample preparation stages located in a sample preparation staging area, and a transport device for transporting a respective one of the sample preparation stages from the sample preparation staging area to the sample analysis area.

In certain preferred embodiments, each of the chromatography columns is packed with chromatography media for processing, purification and/or separation of compounds, such as proteins, under conditions suitable for sample elution from the chromatography columns to be analyzed by mass spectroscopy. For instance, at least a portion of the chromatography columns are packed with affinity chromatography media, hydrophobic chromatography media, ion-exchange chromatography media, gel filtration media, hydroxylapatite media, and/or size exclusion chromatography media.

The chromatography columns of the array can be homogenous with respect to the chromatographic media in each of the chromatography columns. Alternatively, at least a portion of the chromatography columns of the array can be heterologous with respect to the chromatographic media in the respective chromatography columns.

In certain embodiments, the subject columns can include frits at one or both ends.

In certain preferred embodiments, particularly where the arrays are offered for sale, e.g., as a commercial product, device is packaged in association with instructions for utilizing the device in conjunction with mass spectroscopy analysis of effluents of the chromatography columns.

A related aspect of the invention provides a MS-coupled chromatographic apparatus comprising: (a) a plurality of sample preparation stages located in a sample preparation staging area, each stage having a plurality of individually mounted separation columns, each of the separation columns having first and second connecting elements disposed at respective first and second ends of the separation column, said first connecting element of the separation column connectable to a header adapted to drive a content representing a sample and/or a solute through the respective separation column, said second connecting element of the separation column connectable to a capillary line for eluting the content to a MALDI plate, (b) a transport device for transporting a respective one of the MALDI plates from the sample preparation staging area to a sample analysis area, and (c) a mass spectrometer located in the sample analysis area and having an input adapted to receive the MALDI plates for analysis.

Another aspect of the invention relates to an arrayed chromatography device comprising a plurality of individually mounted chromatography columns, with each of the chromatography columns having first and second connecting elements disposed at respective ends of the chromatography column, said first connecting elements of the chromatography columns connectable to a header adapted to drive a content representing a sample and/or a solute through the respective chromatography column, which columns are dimensioned to operate under nanoflow conditions.

In one embodiment, each of the chromatography columns has an inside diameter of between 5 and 200 μm.

In one embodiment, each of the chromatography columns is packed with chromatography media for processing, purification and/or separation of proteins under conditions suitable for the protein samples eluting from the chromatography columns to be analyzed by mass spectroscopy.

In one embodiment, at least a portion of the chromatography columns are packed with affinity chromatography media, hydrophobic chromatography media, ion-exchange chromatography media, gel filtration media, hydroxylapatite media, and/or size exclusion chromatography media.

In one embodiment, the chromatography column include a frit at one or both ends of the column. In a preferred embodiment, each frit is individually selected from: sol-gel, sinter glass, a macro-porous photopolymer or a combination thereof.

In one embodiment, the chromatography column is a fritless column.

In one embodiment, the chromatography columns of the array are homogenous with respect to the chromatographic media in each of the chromatography columns.

In one embodiment, at least a portion of the chromatography columns of the array are heterologous with respect to the chromatographic media in the respective chromatography columns.

In one embodiment, the arrayed chromatography device contains instructions for utilizing the device in conjunction with mass spectroscopy analysis of effluents of the chromatography columns.

In certain embodiments the device can also serve as a precolumn, prior to the analysis of samples by reverse-phase Liquid Chromatography (LC-MS).

In certain embodiments the device can also be utilized for sample storage.

Additional features may be incorporated into the device for use in other applications besides LC-MS (such as SCX: strong cation exchange, SAX: strong anion exchange, SEC: size exclusion chromatography, and IMAC: immobilized metal affinity chromatography).

Another aspect of the invention relates to a mass spectrometer system comprising: (a) a mass spectrometer having an input coupling adapted to receive a column effluent for analysis, (b) at least one sample preparation stage for receiving one or more of the subject arrayed chromatography devices. Preferably, the sample preparation stage includes connecting elements for creating fluid connections with input and output ends of the chromatography columns, and the sample preparation stage moves at least one of the arrayed chromatography device and connecting elements relative to one and other in order select a subset of chromatography columns for adding solution(s) through the input end or coupling the output end to the input coupling of the mass spectrometer.

In certain preferred embodiments, the mass spectrometer system also includes a data storage system including one or more databases for storing data representative of spectra obtained mass spectrometer for effluent samples from the arrayed chromatography device, and an indexing system for indexing said data to identify the origin in the arrayed chromatography device of the analyzed sample.

In certain embodiments, the sample preparation stage is moveable in at least one direction for releasably connecting the second connecting elements of the separation columns sequentially to the input coupling of the mass spectrometer.

In one embodiment, the mass spectrometer system includes at least one sample preparation stage having a plurality of individually mounted separation columns, with each of the separation columns having first and second connecting elements disposed at respective ends of the separation column, said first connecting elements of the separation columns connectable to a header adapted to drive a content representing a sample and/or a solute through the respective separation column.

In certain embodiments, the input coupling of the mass spectrometer couples the effluent of the chromatography columns with an electro-spray ionization (ESI) device.

In certain embodiments, the header includes a common header space for at least a subset of the separation columns with a predetermined pressure. For instance, the system can keep the pressure uniform over the separation columns, or can create a predetermined gradient over the separation columns.

In certain embodiments, the system includes a plurality of sample preparation stages located in a sample preparation staging area, and a transport device for transporting a respective one of the sample preparation stages from the sample preparation staging area to the sample analysis area.

Another aspect of the present invention is a device for generating sample MALDI plates. Such devices can include a plurality of sample preparation stages located in a sample preparation staging area, each stage having a plurality of individually mounted separation columns, and each of the separation columns having first and second connecting elements disposed at respective first and second ends of the separation column. The first connecting element of the separation column are connectable to a header adapted to drive a content representing a sample and/or a solute through the respective separation column, said second connecting element of the separation column connectable to a capillary line for eluting the content to a MALDI plate.

In certain embodiments, the device also includes a transport device for transporting a respective one of the MALDI plates from the sample preparation staging area to a sample analysis area. The sample analysis area can include a MALDI mass spectrometer having an input adapted to receive the MALDI plates for analysis.

The invention also provides a chromatographic device/apparatus including: (a) the above-described device for generating sample MALDI plates; (b) the transport device for transporting a respective one of the MALDI plates from the sample preparation staging area to a sample analysis area, and (c) a mass spectrometer located in the sample analysis area and having an input adapted to receive the MALDI plates for analysis.

Another aspect of the invention provides a method for conducting a reagent business, and includes providing a distribution system for distributing the subject arrayed chromatography devices, along with providing marketing materials for teaching potential customers about using the arrayed chromatography device in conjunction with mass spectroscopy analysis of effluents of the chromatography columns. In certain embodiments, the method also includes a distribution system for distributing software for use with a mass spectrometer for indexing data based on the origin of an analyzed sample from the arrayed chromatography device.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 is a cross-sectional view of a single column unit;

FIG. 2 is a cross-sectional view of a single column unit of an NanoLC array with an internal frit;

FIG. 3 is a cross-sectional view of a single column unit of the NanoLC array with an external frit;

FIG. 4 is a top view of a plate holding eight column units in a linear NanoLC array;

FIG. 5 is a connector for a single column unit of the NanoLC array;

FIG. 6 is a cross-sectional view of an NanoLC array with a common head space;

FIG. 7 is a cross-sectional view of an NanoLC array with individual pressure connections to each column unit;

FIG. 8 shows the cross-sectional view of an NanoLC array with a common head space of

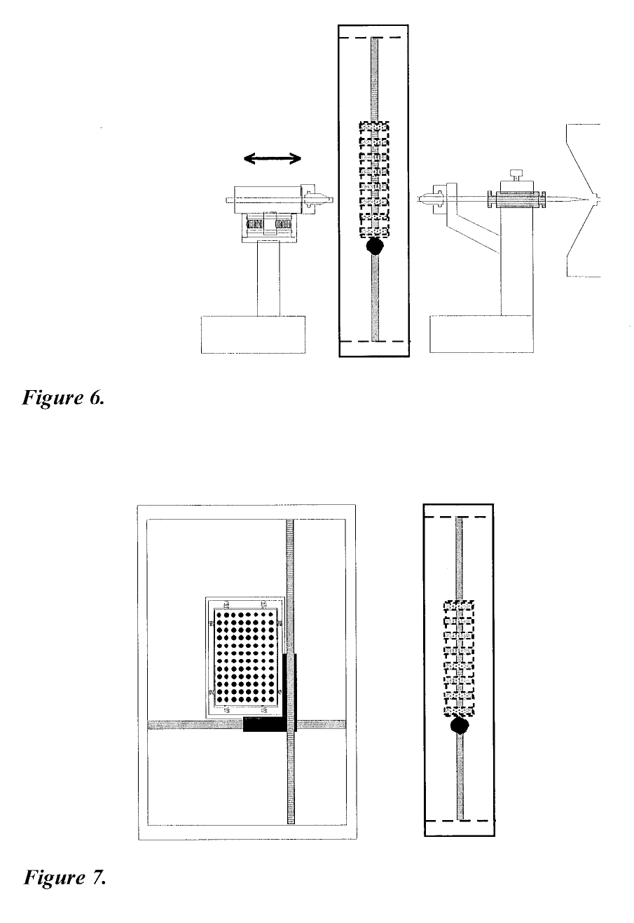

FIG. 6 for preparation of MALDI plates;

FIG. 9 is a top and side view of a moveable X-Y stage holding an NanoLC array;

FIG. 10 shows the moveable X-Y stage with the NanoLC array positioned for mass spectroscopic analysis; and

FIG. 11 shows an integrated system having multiple solvents for mass spectroscopic analysis.

### DETAILED DESCRIPTION OF CERTAIN ILLUSTRATED EMBODIMENTS

One aspect of the present invention relates to an arrayed arrangement of a plurality of micro-LC columns adapted for off-line sample preparation, referred to herein as a “nanoLC array”. In particular, the nanoLC arrays described herein can operate under nanoflow conditions, with samples being eluted from the columns of the array pressurizing the headspace above the columns with gas(es) or liquid(s). As used herein, the term “nanoflow” refers to liquid flow rates less than 1 μl/min.

Another aspect of the invention is directed to a liquid chromatography/mass spectrometry (LC/MS) system for high throughput mass spectrometry analysis that includes the subject nanoLC arrays. In an illustrative embodiment, the device is composed of two parts: a nanoLC array, and an X-Y “translator” apparatus that presents the samples eluting from the NanoLC array sequentially to a mass spectrometer for analysis. The samples can be analyzed by mass spectrometry using, merely to illustrate, either MALDI or electro-spray ionization (ESI) techniques.

Yet another aspect of the invention concerns a spectrometer, an X-Y translator apparatus for receiving one or more nanoLC arrays, and a process control device for controlling/tracking the X-Y translator, and indexing MS spectra data based on the origin of the analyzed sample, e.g., from which column the sample was eluted.

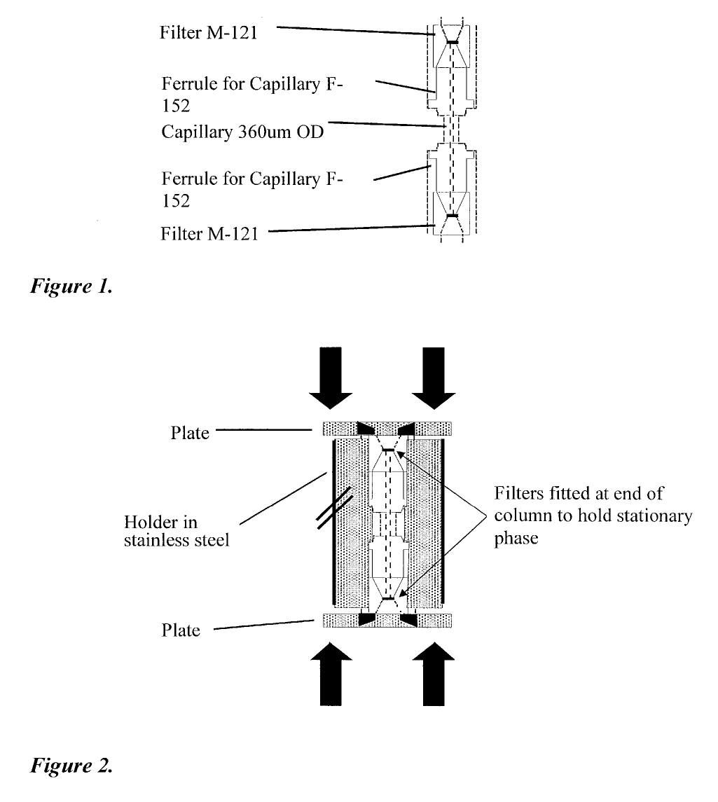

Referring first to FIG. 1, an exemplary individual column assembly 10 of an NanoLC array includes a nano-LC column 16 that is 1-5 cm long and has an external diameter of approximately 360 μm and an internal diameter between 20-200 μm. The LC column 16 can be packed with conventional stationary phase (not shown) and can be connected at its respective ends by a female connector (ferrule) 12 designed to allow a zero dead volume connection. In addition, filters 14 can be attached to the respective ends of the column to hold the stationary phase in place. The filters may have external frits, as shown with the reference numeral 14 in FIG. 1, or internal frits, as shown with the reference numeral 24 in FIG. 2. The filters 14, 24 may be made of materials such as monolithic sol-gel, sinter glass, or a macro-porous photopolymer. The exemplary filter 14 of FIG. 1 is a Model M-121 Mini Microfilter with a 1 μm pore size; the ferrule 12 is a Model F-152, both available from Upchurch Scientific, Oak Harbor, Wash. USA.

When included, the frits are commonly located at one or both ends of the column in order to contain the particulate packing material within the column. The frit at the head of a column may also serves to trap particulate material. In addition to the materials mentioned above, the frit may also be designed to trap particulate metal ions released from another part of the liquid chromatography system. Ionic contamination from metals can exist in two forms. One form is dissolved metal ions. In another form, metals ions can exist in the colloidal state. For example, colloidal iron can be present, even in “high purity” megohm water. Any metal or other ion that can interact with the analytes (e.g., proteins and peptides) could cause potentially harmful chromatographic effects when the metal becomes trapped on the chromatographic column. Magnesium and/or calcium and other ions can be present in samples.

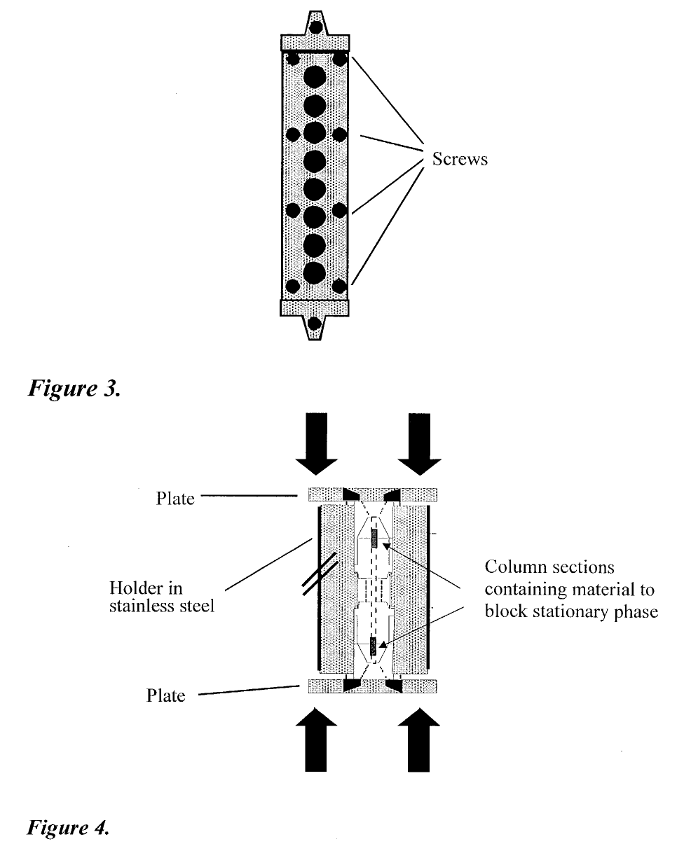

Referring now to FIGS. 2 and 3, the LC column assembly 10 having the outside frit (FIG. 1) and the LC column assembly 20 of FIG. 2 having the inside frit can be held together, for example in an array pattern, by placing the individual column assemblies 10, 20 between plates 32, 34. Seals 36, 38 are provided to seal the column assemblies 10, 20 against the plates 36, 38. The plates 36, 38 can be made of a metal, such as stainless steel and secured by screws 42, as shown in FIG. 4 which depicts an exemplary 1×8 NanoLC array 40. To provide stability during assembly of the array and when the column assemblies 10, 20 are tensioned, as indicated by the solid arrows, by the screws 42, the individual column assemblies 10, 20 can be surrounded by holders 39, made for example of stainless steel. Those skilled in the art will appreciate that larger arrays, such as arrays containing between 96 and potentially 384 individual column assemblies can be assembled by the same process.

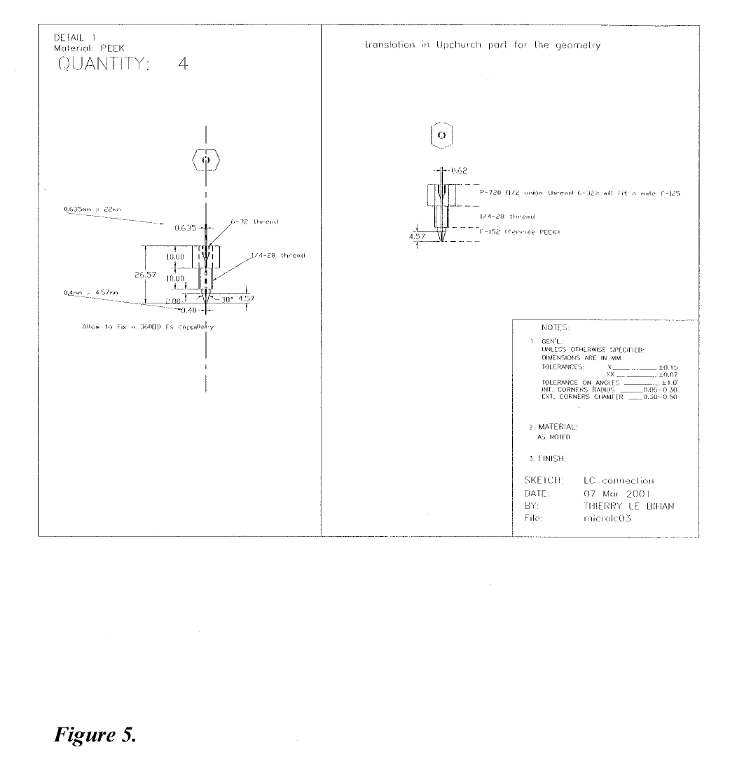

FIG. 5 shows in greater detail the elements used for connecting the column assemblies 10, 20 of the NanoLC array.

As indicated in FIG. 6, individual columns 62 can be held in a column holder 64 that fit a conventional well format, such as a 96-well format of 73 mm×120 mm, with the columns spaced by approximately 9 mm. The liquid can be driven either by vacuum 66 or pressure 68. The NanoLC array arranged in the column holder can be connected to a headspace 62 that can be common for all or at least some of the column assemblies 60 and capable of being pressurized to drive the contents through the individually mounted columns for separation. As mentioned above, this process can be performed on individual columns or, preferably, on all (96) columns simultaneously to increase sample throughput. Alternatively, individual columns can be pressurized separately to provide, for example, a pressure gradient, as indicated in FIG. 7 by pressure connections 72.

Two specific applications are presented; 1) using the invention as a desalting unit for the preparation of samples for MALDI-MS analysis, and 2) using the invention to analyze samples using nanoflow ESI-MS.

Samples may contain significant concentrations of salts (e.g., sodium chloride) as well as other non-volatile reagents which may interfere with the MS analysis. For example, the presence of small to moderate amounts of sodium salts has been shown to affect electrospray stability due to changes in solution conductivity, and may significantly reduce the detected analyte ion abundance due to both suppression of ionization and the formation of multiple species having sodium adducts. Likewise, peptide analysis using MALDI-MS analysis generally requires the sample to be desalted before analysis using mass spectrometry since the presence of salt significantly reduces mass spectrometer performance. Low signal-to-noise ratios of the mass spectra and poor reproducibility due to excessive adduction can result in inaccurate mass assignments and, in severe cases, even preclude spectrum interpretation.

Sodium adduct formation is attributed primarily to electrostatic interactions of sodium ions with negatively charged sites on the high molecular weight molecules, e.g. phosphate groups on the polynucleotide backbone in DNA. Large DNA molecules have a proportionally higher affinity for sodium ion because of the extended polynucleotide backbone. Therefore, removal of sodium ion from large DNA molecules to the levels required to produce high quality spectra is more difficult than for small oligonucleotides.

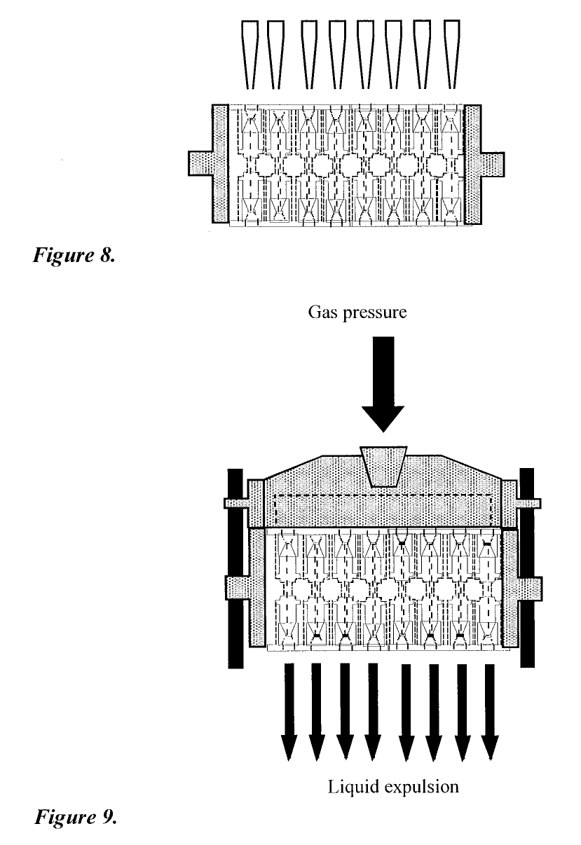

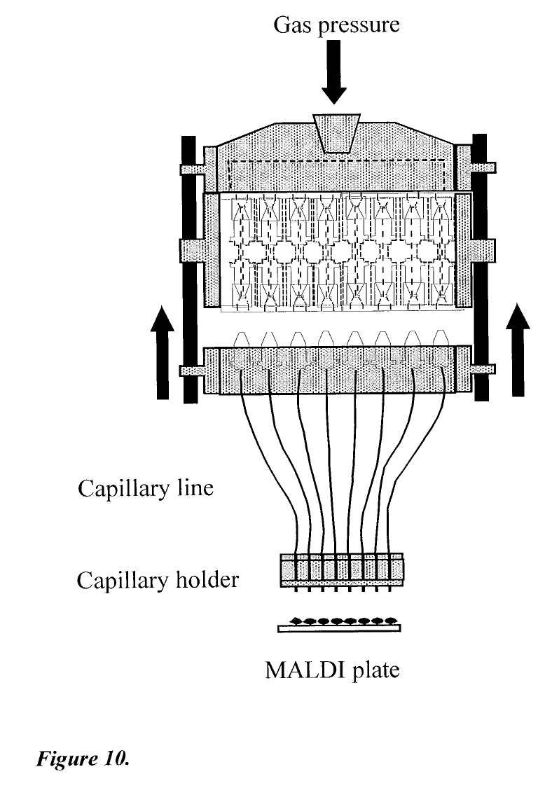

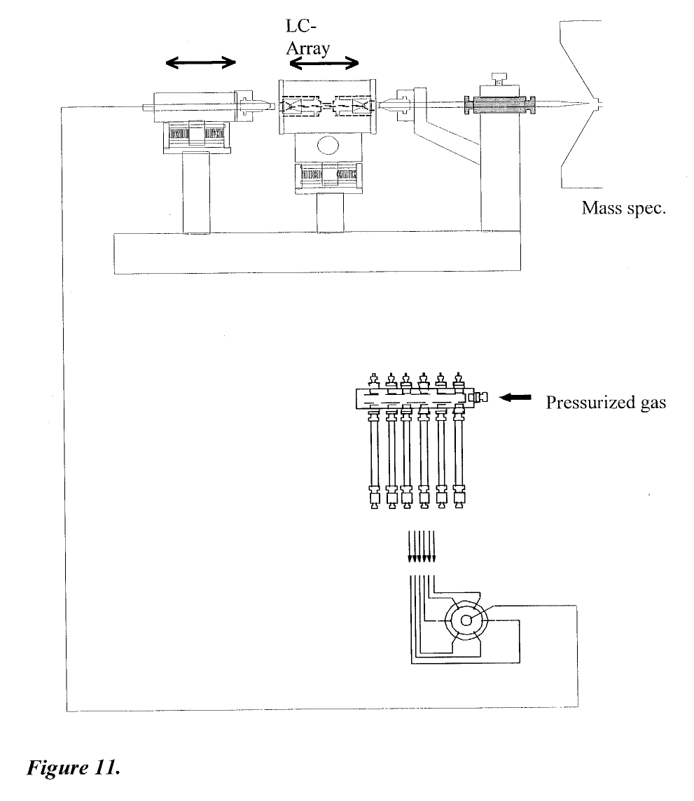

Referring now back to FIG. 6 and also to FIGS. 7 and 8, in an application as a desalting unit, protein samples (not shown) are loaded onto the tops of individual columns 70, 80 of the NanoLC array, which are filled with a reverse-phase packing, such as C18-coated beads (not shown). As the samples are passed through the columns 60, 70, 80, peptides are held up by the packing while the salt (dissolved in the effluent) passes out as waste, as indicated by arrows 69 in the example of FIG. 6. For preparing MALDI samples, the peptides are rinsed to ensure that contaminants are minimized and then eluted through an array of capillary lines 82 which are attached to the ends of each individual column by ferrules 84, as indicated in FIG. 8. The capillaries are aligned directly above a MALDI (Matrix-Assisted Laser Desorption/Ionization Mass Spectrometry) plate 86 by a capillary holder 87, allowing the exact placement of each spot 88 on the plate 86 (FIG. 8). The MALDI matrix and the support are dried and transferred to the vacuum gate of the mass spectrometer for commencement of the MALDI experiment. The MALDI ionization surface may be modified for analyte capture to permit additional rinsing of the sample surface to remove unbound species.

The MALDI-MS technique is based on the discovery in the late 1980s that an analyte consisting of, for example, large nonvolatile molecules such as proteins, embedded in a solid or crystalline “matrix” of laser light-absorbing molecules can be desorbed by laser irradiation and ionized from the solid phase into the gaseous or vapor phase, and accelerated as intact molecular ions towards a detector of a mass spectrometer. The “matrix” is typically a small organic acid mixed in solution with the analyte in a 10,000:1 molar ratio of matrix/analyte. The matrix solution can be adjusted to neutral pH before mixing with the analyte.

The MALDI ionization surface may be composed of an inert material or else modified to actively capture an analyte. For example, an analyte binding partner may be bound to the surface to selectively absorb a target analyte or the surface may be coated with a thin nitrocellulose film for nonselective binding to the analyte. The surface may also be used as a reaction zone upon which the analyte is chemically modified, e.g., CNBr degradation of protein. See Bai et al, Anal. Chem. 67, 1705-1710 (1995).

Metals such as gold, copper and stainless steel are typically used to form MALDI ionization surfaces of plate 86. However, other commercially-available inert materials (e.g., glass, silica, nylon and other synthetic polymers, agarose and other carbohydrate polymers, and plastics) can be used where it is desired to use the surface as a capture region or reaction zone. The use of Nation and nitrocellulose-coated MALDI probes for on-probe purification of PCR-amplified gene sequences is described by Liu et at, Rapid Commun. Mass Spec. 9:735-743 (1995). Tang et al have reported the attachment of purified oligonucleotides to beads, the tethering of beads to a probe element, and the use of this technique to capture a complimentary DNA sequence for analysis by MALDI-TOF MS (reported by K. Tang et at, at the May 1995 TOF-MS workshop, R. J. Cotter (Chairperson); K. Tang et al, Nucleic Acids Res. 23, 3126-3131, 1995). Alternatively, the MALDI surface may be electrically- or magnetically activated to capture charged analytes and analytes anchored to magnetic beads respectively.

As seen from the foregoing description of, for example, FIGS. 6 and 7, desalting and preparation of MALDI samples can be performed offline, possibly by applying pressure and/or vacuum to all columns simultaneously or to individual columns separately. Accordingly, the total throughput of the system can be increased, since sample preparation may take from several minutes to hours, whereas mass spectrometric analysis of a sample may only take a minute or two. Many LC operations, such as washing the columns, equilibrating the columns, loading samples, and desalting, are therefore best performed offline (not in front of the mass spectrometer) with a conventional liquid handler (FIGS. 6 and 7). As mentioned above, the liquid can be driven either by vacuum or pressure.

Aside from MALDI, Electrospray Ionization Mass Spectrometry (ESI/MS) has been recognized as a significant tool used in the study of proteins, protein complexes and bio-molecules in general. ESI is a method of sample introduction for mass spectrometric analysis whereby ions are formed at atmospheric pressure and then introduced into a mass spectrometer using a special interface. Large organic molecules, of molecular weight over 10,000 Daltons, may be analyzed in a quadrupole mass spectrometer using ESI.

In ESI, a sample solution containing molecules of interest and a solvent is pumped into an electrospray chamber through a fine needle. An electrical potential of several kilovolts may be applied to the needle for generating a fine spray of charged droplets. The droplets may be sprayed at atmospheric pressure into a chamber containing a heated gas to vaporize the solvent. Alternatively, the needle may extend into an evacuated chamber, and the sprayed droplets are then heated in the evacuated chamber. The fine spray of highly charged droplets releases molecular ions as the droplets vaporize at atmospheric pressure. In either case, ions are focused into a beam, which is accelerated by an electric field, and then analyzed in a mass spectrometer.

Because electrospray ionization occurs directly from solution at atmospheric pressure, the ions formed in this process tend to be strongly solvated. To carry out meaningful mass measurements, solvent molecules attached to the ions should be efficiently removed, that is, the molecules of interest should be “desolvated”. Desolvation can, for example, be achieved by interacting the droplets and solvated ions with a strong countercurrent flow (6-9l/m) of a heated gas before the ions enter into the vacuum of the mass analyzer.

As depicted in FIG. 9, the entire NanoLC array 92 can be placed in an X-Y translator apparatus 90 having a movable X-Y stage 94 to allow direct mass spectroscopic analysis using ESI of the column effluent. The NanoLC array 92 can be placed between a solvent delivery device 102 and an ESI inlet device 104, as depicted in FIG. 10. The solvent delivery device 102 elutes the contents of individual columns by pumping liquid through each column, as seen from FIGS. 6-8, while the ESI device 104 ionizes the effluent and injects the stream into a mass spectrometer 106. The movable X-Y stage 94 allows alignment of individual columns 91 between the solvent delivery device 102 and the ESI inlet 104 (FIG. 10). The solvent delivery device 102 is connected to a respective column 91 by a capillary holder and a ferrule fitting 103 that fits tightly into the column inlet to allow a leak-tight seal, as described above with reference to FIGS. 2, 3 and 5. The other side of the column 91 is directly connected by a similar ferrule fitting to the ESI tip 105. Commercially available (capillary HPLC) or customized gradient generators may be used as the solvent delivery device. Alternatively, the columns can be connected manually to a respective inlet/outlet port (FIG. 7).

The column outlet is directly connected to the ESI sprayer 107 (FIG. 10), which can be either a standard tip, a tip packed with a liquid chromatographic (LC) packing material, or a monolithic polymer (to increase the separation efficiency of the NanoLC array).

Before the ESI-MS analysis, the samples can be loaded and rinsed (desalted) as described above with reference to the MALDI process. Once the peptides have been washed, the plate is removed from the NanoLC array holder and placed in the translator apparatus, as more clearly shown in FIG. 11. The solvent delivery system 102 and ESI attachment 104 (FIG. 11) are aligned by pressing the attachment ferrules 113, 115 into the respective inlet/outlet of the particular column, either manually or automatically. The column contents are eluted by flowing solvents from one or more reservoir systems 120a, . . . , 120f through each column. An exemplary design with six solvent reservoirs 120a, . . . , 120f that are computer-controlled by a 6-position valve 122, which is connected to a pressurized gas line 124, is depicted in FIG. 11. As known in the art, suitable solvents are selected depending on the specific application. Both the positioning of the X-Y translator stage 94 and the analysis in the mass spectrometer 106 can be controlled by computer software, allowing automated sample processing of all columns of the NanoLC array 92.

As mentioned above, the present embodiment operates in the nanoflow regime, with liquid flow rates less than 1 μl/min. The use of nanoflow chromatography is a significant advantage for the study of proteins and peptides. As a general rule, the greater the concentration of a peptide in a sample, the better the results of the analysis. Since the absolute number of peptides from a sample often cannot be controlled (and is often very small), reduction of the sample volume is essential for creating concentrated peptide samples. It has also been shown that the sensitivity of ESI mass spectrometry measurements is dramatically increased when sample flow rates are in the nanoflow regime. Unfortunately, small volumes are not compatible with traditional liquid chromatographic techniques that use higher flow rates. However, the use of liquid chromatography in the nanoflow regime has proven to be challenging.

By using the process described above, the duty cycle of the LC separation can be optimized. The “duty cycle” is defined as the ratio between the analysis time (peptide elution) and the total time of a normal LC run (including equilibration step, sample loading, desalting step, analysis step, and washing). This ratio is normally low since increasing the efficiency of the duty cycle is often done at the expense of LC column performance (cross contamination, poor separation). The process according to the invention increases the duty cycle while eliminating many of these disadvantages, since the LC operation can be performed offline (equilibrating the column, load sample, desalting and wash the column) while only the peptide elution is performed while connected to the mass spectrometer. By decoupling the sample preparation from the sample analysis; a wide variety of sample analysis methods can be offered. Fractions of column effluent from individual LC columns in the array can be captured in standard well-plates or spotted directly onto membranes which can be stored for analysis at a later date. Samples can also be spotted directly on MALDI plates for later use in MALDI-MS analysis, as mentioned above.

The NanoLC array system and method can be used for the simultaneous chromatographic processing of multiple samples, in particular NanoLC arrays with 96 or 384 samples or “well plates”, which are common standards for biological sample storage and preparation.

While the invention has been disclosed in connection with separating individual or multiple liquid samples into constituent parts through the use of nanoflow liquid chromatography, various modifications and improvements thereon will become readily apparent to those skilled in the art, such as chromatographic processes that include affinity chromatography, hydrophobic chromatography such as reverse phase, ion-exchange chromatography, gel filtration, hydroxylapatite chromatography, and size exclusion chromatography.

The nanoLC array may be homogenous with respect to the chromatographic media in each column, or may vary from one column to the next or from one set of columns to the next. The homogeneous arrays are particularly useful for parallel processing of many different samples. On the other hand, the heterogeneous array can be used to analyze a smaller set of samples, but under multiple different chromatographic conditions.

The columns may each be packed with more than one chromatographic media. For instance, multiple layered columns can be used in which samples eluting from one portion of the column are contiguously passed to the next column portion. Merely to illustrate, a column for processing proteins for MS analysis can have a first preparatory portion, e.g., for desalting or ion exchange, a trypsin portion for cleaving the proteins into shorter peptides, and a third portion for separating the trypsin fragments into discrete eluting bands based on such criteria as size, hydrophobicity, etc.

In certain preferred embodiments, the nanoLC columns are selected for separation of protein mixtures, e.g., to purify proteins from contaminates and/or separate the proteins into discrete populations for analysis.

In certain embodiments the device can also serve as a precolumn, prior to the analysis of samples by reverse-phase Liquid Chromatography (LC-MS). In this arrangement, different complex mixtures can be loaded from the device, which limits any carry-over from one sample to another, thus reducing the need for extensive in-line precolumn washes. In a related embodiment this arrangement can also be used to de-salt samples prior to analysis.

In certain embodiments the device can also be utilized for sample storage. In this arrangement the device is an improvement over the conventional 96-well plate in that the sample is loaded into the device and stored (as is, or, for example, in the presence of an anti-bacterial agent to reduce sample degradation) for further processing. Such anti-bacterial agents are well-known in the art, including but are not limited to ampecillin, tetracyclin, etc.

Additional features may be incorporated into the device for use in other applications besides LC-MS (such as SCX: strong cation exchange, SAX: strong anion exchange, SEC: size exclusion chromatography, and IMAC: immobilized metal affinity chromatography). Such features include, but are not limited to, a precise silica diamond cutter mounted on a bearing along the device, the cutter having an adjustable micrometer which allows columns of different length to be prepared in situ, the incorporation of a sol-gel for use as a filter, and a framework for mounting such a device no matter which set-up or application is employed.

The sample may or may not be biological in nature. Although the exemplary embodiments are directed to either a direct sample analysis using ESI-MS or an indirect sample analysis using MALDI-MS, these analyses are merely exemplary. Additional analytical techniques, including fluorometry or other types of spectroscopy, could also be adopted for use with the invention. Accordingly, the spirit and scope of the present invention is to be limited only by the following claims.

What is claimed is:

1. A mass spectrometer-coupled chromatographic apparatus comprising:
(a) at least one sample preparation stage having a plurality of individually mounted separation columns, with each of the separation columns having first and second connecting elements disposed at respective ends of the separation column, said first connecting elements of the separation columns connectable to a header adapted to drive a content representing a sample and/or a solute through the respective separation column, and
(b) a mass spectrometer located in a sample analysis area and having an input coupling adapted to receive a column effluent for analysis,
wherein the sample preparation stage is moveable in at least one direction for releasably connecting the second connecting elements of the separation columns sequentially to the input coupling of the mass spectrometer.

2. The apparatus of claim 1, wherein the input coupling of the mass spectrometer includes an electro-spray ionization (ESI) device.

3. The apparatus of claim 1, wherein each of the separation columns of the plurality of columns has an inside diameter of between 5 and 200 μm.

4. The apparatus of claim 1, wherein separation columns operate efficiently at a flow rate of the sample and/or solute through the respective separation column of liquid flow rates of less than 1 μl/min.

5. The apparatus of claim 1, wherein said header includes a common header space for at least a subset of the separation columns with a predetermined pressure.

6. The apparatus of claim 5, wherein said pressure is uniform over the separation columns.

7. The apparatus of claim 5, wherein said pressure has a predetermined gradient over the separation columns.

8. The apparatus of claim 1, comprising a plurality of sample preparation stages located in a sample preparation staging area, and a transport device for transporting a respective one of the sample preparation stages from the sample preparation staging area to the sample analysis area.

9. A mass spectrometer-coupled chromatographic apparatus comprising:
(a) a plurality of sample preparation stages located in a sample preparation staging area, each stage having a plurality of individually mounted separation columns, each of the separation columns having first and second connecting elements disposed at respective first and second ends of the separation column, said first connecting element of the separation column connectable to a header adapted to drive a content representing a sample and/or a solute through the respective separation column, said second connecting element of the separation column connectable to a capillary line for eluting the content to a MALDI plate,
(b) a transport device for transporting a respective one of the MALDI plates from the sample preparation staging area to a sample analysis area, and
(c) a mass spectrometer located in the sample analysis area and having an input adapted to receive the MALDI plates for analysis.

10. An arrayed chromatography device comprising a plurality of individually mounted chromatography columns, with each of the chromatography columns having first and second connecting elements disposed at respective ends of the chromatography column, said first connecting elements of the chromatography columns connectable to a header adapted to drive a content representing a sample and/or a solute through the respective chromatography column, which columns are dimensioned to operate under nanoflow conditions.

11. The arrayed chromatography device of claim 10, wherein each of the chromatography columns has an inside diameter of between 5 and 200 μm.

12. The arrayed chromatography device of claim 10, wherein each of the chromatography columns is packed with chromatography media for processing, purification and/or separation of samples under conditions suitable for said samples eluting from the chromatography columns to be analyzed by mass spectroscopy.

13. The arrayed chromatography device of claim 10, wherein at least a portion of the chromatography columns are packed with one or more of: affinity chromatography media, hydrophobic chromatography media, ion-exchange chromatography media, gel filtration media, hydroxylapatite media, and size exclusion chromatography media.

14. The arrayed chromatography device of claim 10, wherein the chromatography column include a frit at one or both ends of the column.

15. The arrayed chromatography device of claim 14, wherein each frit is individually selected from: sol-gel, sinter glass, a macro-porous photopolymer or a combination thereof.

16. The arrayed chromatography device of claim 10, wherein the chromatography column is a fritless column.

17. The arrayed chromatography device of claim 10, wherein the chromatography columns of the array are homogenous with respect to the chromatographic media in each of the chromatography columns.

18. The arrayed chromatography device of claim 10, wherein at least a portion of the chromatography columns of the array are heterologous with respect to the chromatographic media in the respective chromatography columns.

19. The arrayed chromatography device of claim 10, wherein the device serves as a precolumn prior to the analysis of samples by reverse-phase Liquid Chromatography (LC-MS).

20. The arrayed chromatography device of claim 19, wherein the precolumn is utilized for de-salting samples prior to analysis.

21. The arrayed chromatography device of claim 10, wherein the device is utilized for sample storage.

22. The arrayed chromatography device of claim 21, wherein the device contains an anti-bacterial agent to reduce sample degradation.

23. The arrayed chromatography device of claim 10, wherein the device includes additional features for use in applications other than LC-MS, said application is SCX (strong cation exchange), SAX (strong anion exchange), SEC (size exclusion chromatography), or IMAC (immobilized metal affinity chromatography).

24. The arrayed chromatography device of claim 23, wherein the additional feature is: a precise silica diamond cutter mounted on a bearing along the device, said cutter having an adjustable micrometer that allows columns of different length to be prepared in situ; a sol-gel for use as a filter; or a framework for mounting said device.

25. The arrayed chromatography device of claim 10, in association with instructions for utilizing the device in conjunction with mass spectroscopy analysis of effluents of the chromatography columns.

26. A method for conducting a reagent business, comprising:
(a) providing a distribution system for distributing the arrayed chromatography device of claim 10;
(b) providing marketing materials for teaching potential customers about using the arrayed chromatography device in conjunction with mass spectroscopy analysis of effluents of the chromatography columns.

27. The method of claim 26, further comprising a distribution system for distributing software for use with a mass spectrometer for indexing data based on the origin of an analyzed sample from the arrayed chromatography device.

28. A mass spectrometer system comprising:
(a) a mass spectrometer having an input coupling adapted to receive a column effluent for analysis,
(b) at least one sample preparation stage for receiving the arrayed chromatography device of claim 10, which sample preparation stage includes connecting elements for creating fluid connections with input and output ends of the chromatography columns, and which sample preparation stage moves at least one of the arrayed chromatography device and connecting elements relative to one and other in order select a subset of chromatography columns for adding solution(s) through said input end or coupling said output end to the input coupling of the mass spectrometer;
(c) a data storage system including one or more databases for storing data representative of spectra obtained mass spectrometer for effluent samples from the arrayed chromatography device, and an indexing system for indexing said data to identify the origin in the arrayed chromatography device of the analyzed sample.
